(19) United States
(12) Patent Application Publication
(10) Pub. No.: US 2023/0253609 A1
(43) Pub. Date: Aug. 10, 2023

(54) SECONDARY BATTERY AND METHOD FOR MANUFACTURING THE SAME

(71) Applicant: LG ENERGY SOLUTION, LTD., Seoul (KR)

(72) Inventors: Dae Eun YU, Daejeon (KR); Yong Gon LEE, Daejeon (KR); Yeong Hun JUNG, Daejeon (KR)

(73) Assignee: LG ENERGY SOLUTION, LTD., Seoul (KR)

(21) Appl. No.: 18/010,237

(22) PCT Filed: Jun. 14, 2021
(86) PCT No.: PCT/KR2021/007400

§ 371 Date: Dec. 14, 2022

(30) Foreign Application Priority Data
Jun. 15, 2020 (KR) 10-2020-0072599

(51) Int. Cl. H01M 10/04; H01M 50/107; H01M 50/636; H01M 50/46

(52) U.S. Cl. CPC H01M 10/049; H01M 10/0468; H01M 50/107; H01M 50/636; H01M 50/46

(57) ABSTRACT

A method for manufacturing a secondary battery according includes accommodating an electrode assembly, in which electrodes and separators are alternately stacked, in a can type battery case; primarily injecting an electrolyte through an injection hole; applying a pressure to the battery case while performing a formation process in a state in which the injection hole is opened; secondarily injecting the electrolyte through the injection hole after performing the formation process, and closing the injection hole.

### CROSS-REFERENCE TO RELATED APPLICATION

The present application claims the benefit of the priority of Korean Patent Application No. 10-2020-0072599, filed on Jun. 15, 2020, which is hereby incorporated by reference in its entirety.

### TECHNICAL FIELD

The present invention relates to a secondary battery and a method for manufacturing the same, and more particularly, to a secondary battery in which a swelling phenomenon of an electrode assembly is prevented, and a plurality of unit cells are be laminated due to a pressure inside a battery case, and a method for manufacturing the same.

### BACKGROUND ART

In general, secondary batteries include nickel-cadmium batteries, nickel-hydrogen batteries, lithium ion batteries, and lithium ion polymer batteries. Such a secondary battery is being applied to be used in small-sized products such as digital cameras, P-DVDs, MP3Ps, mobile phones, PDAs, portable game devices, power tools, E-bikes, and the like as well as large-sized products requiring high power such as electric vehicles and hybrid vehicles, power storage devices for storing surplus power or renewable energy, and backup power storage devices.

In general, in order to manufacture the lithium secondary battery, first, electrode active material slurry is applied to a positive electrode collector and a negative electrode collector to manufacture a positive electrode (cathode) and a negative electrode (anode). Then, the electrodes are laminated on both sides of a separator form an electrode assembly. Also, the electrode assembly is accommodated in a battery case, and then the battery case is sealed after an electrolyte is injected therein.

Such a secondary battery is classified into a pouch type secondary battery and a can type secondary battery according to a material of a case accommodating the electrode assembly. In the pouch-type secondary battery, the electrode assembly is accommodated in a pouch made of a flexible polymer material having a variable shape. Also, in the can type secondary battery, an electrode assembly is accommodated in a case made of a metal or plastic material having a predetermined shape. The can type secondary battery is classified into a prismatic type secondary battery in which the case has a polygonal shape and a cylinder type secondary battery in which the case has a cylindrical shape according to the shape of the case.

In the pouch type secondary battery, an injection hole is sealed after an electrolyte is injected into a pouch type battery case, and then, a formation process is performed. Also, a hole is punched in a degassing part formed at one side of the pouch to perform a degassing process for discharging a gas generated in the battery. Thereafter, the pouch is re-sealed, and the degassing part is removed.

As described above, in the pouch type secondary battery, since the formation process is performed after the injection hole is completely closed, a charging rate may be high, and the gas may be quickly discharged. Thus, the secondary battery may be manufactured within a predetermined process time.

However, in a can type secondary battery, when an electrolyte is injected into a can type battery case, and a formation process is performed, an injection hole may not be completely closed. If the formation process is performed after the injection hole is completely closed, unlike the pouch type battery case, if a volume of the battery case is expanded once due to generation of a gas, it is very difficult to return to its original state after the degassing process.

In addition, since the can type battery case is made of a material having rigidity such as a metal or plastic, it is impossible to reseal the battery case after the degassing hole is punched. Therefore, before closing the injection hole, a primary electrolyte is first injected, and a formation process is performed in a dry room to prevent moisture from being permeated. Then, after the gas is discharged to some extent, a secondary electrolyte is injected, and the injection hole is closed.

However, when the above-described method is performed, in order to complete the manufacture of the secondary battery within a predetermined process time, the injection hole has to be closed in a state in which the gas is not completely discharged. Thus, only a portion of the gas is discharged, and the gas partially remains within the case. As a swelling phenomenon in which the electrode assembly swells by the remaining gas occurs, there is a problem in that the manufactured secondary battery increases in thickness.

### PRIOR ART DOCUMENTS

### Patent Documents

Korean Patent Registration No. 1002783

### DISCLOSURE OF THE INVENTION

### Technical Problem

An object of the present invention is to provide a method for manufacturing a secondary battery in which a swelling phenomenon of an electrode assembly is prevented, and a plurality of unit cells are be laminated due to a pressure inside a battery case.

The objects of the present invention are not limited to the aforementioned object, but other objects not described herein will be clearly understood by those skilled in the art from descriptions below.

### Technical Solution

A method for manufacturing a secondary battery according to an embodiment of the present invention for achieving the above object includes: accommodating an electrode assembly, in which electrodes and separators are alternately stacked, in a can type battery case; primarily injecting an electrolyte through an injection hole; applying a pressure to the battery case while performing a formation process in a state in which the injection hole is opened; secondarily injecting the electrolyte through the injection hole after performing the formation process; and closing the injection hole.

In addition, the electrode assembly may be a stack type electrode assembly in which at least portions of the electrodes and the separators are laminated.

In addition, the applying of the pressure while performing the formation process may include: applying a primary pressure as a first pressure while performing a primary formation process; and applying a secondary pressure as a second pressure that is greater than the first pressure while performing a secondary formation process.

In addition, the first pressure may be 0.5 kgf/cm² to 1 kgf/cm², and the second pressure may be 4.5 kgf/cm² to 10 kgf/cm².

In addition, in the performing of the primary formation process, a charging rate may be 23% or less.

In addition, in the performing of the secondary formation process, a charging rate may be 70% or less.

In addition, in the applying of the pressure while performing the formation process, the battery case may be heated.

In addition, the battery case may be heated at a temperature of 55° C. to 65° C.

In addition, the method may further include performing aging after the primarily injecting of the electrolyte and before the applying of the pressure while performing the formation process.

In addition, in the performing of the aging, a temperature for the aging may be 20° C. to 30° C.

In addition, in the secondarily injecting of the electrolyte, a gas remaining in the battery case may be discharged to the outside.

A secondary battery manufactured according to the foregoing method may include the electrode assembly as a stack type electrode assembly, wherein at least portions of the electrodes and the separators are laminated with each other, and the can type battery case may have a constant outer appearance.

Other particularities of the embodiments are included in the detailed description and drawings.

### Advantageous Effects

According to the embodiments of the present invention, there are at least the following effects.

Since the secondary battery is pressed while performing the formation process of the can type secondary battery, the gas may be effectively discharged to the outside to prevent the electrode assembly from swelling and to shorten the manufacturing process.

In addition, even if the stack type electrode assembly, not the jelly roll type electrode assembly, is accommodated in the can type battery case, the plurality of unit cells may be laminated due to the pressure inside the battery case.

The effects of the prevent invention are not limited by the aforementioned description, and thus, more varied effects are involved in this specification.

### BRIEF DESCRIPTION OF THE DRAWINGS

FIG. 1 is a flowchart illustrating a method for manufacturing a secondary battery according to an embodiment of the present invention.

FIG. 2 is a schematic view illustrating a state in which an electrolyte is primarily injected into the secondary battery according to an embodiment of the prevent invention.

FIG. 3 is a schematic view illustrating a state in which a can type secondary battery swells.

FIG. 4 is a schematic view illustrating a state in which the secondary battery is pressed by a jig according to an embodiment of the present invention.

FIG. 5 is a schematic view illustrating a state in which an electrolyte is secondarily injected into the secondary battery according to an embodiment of the prevent invention.

### MODE FOR CARRYING OUT THE INVENTION

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

Unless terms used in the present invention are defined differently, all terms (including technical and scientific terms) used herein have the same meaning as generally understood by those skilled in the art. Also, unless defined clearly and apparently in the description, the terms as defined in a commonly used dictionary are not ideally or excessively construed as having formal meaning.

In the following description, the technical terms are used only for explaining a specific exemplary embodiment while not limiting the present invention. In this specification, the terms of a singular form may include plural forms unless specifically mentioned. The meaning of “includes (comprises)” and/or “including (comprising)” does not exclude other components besides a mentioned component.

Hereinafter, preferred embodiments will be described in detail with reference to the accompanying drawings.

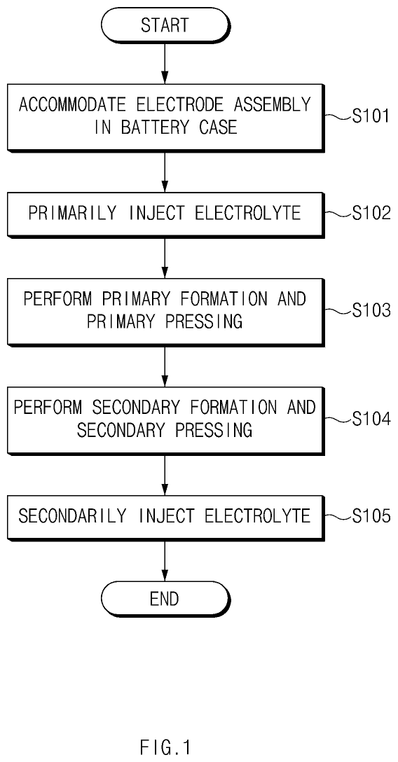

FIG. 1 is a flowchart illustrating a method for manufacturing a secondary battery 1 according to an embodiment of the present invention.

According to the present invention, since the secondary battery 1 is pressed while performing a formation process of a can type secondary battery 1, a gas may be effectively discharged to the outside to prevent the electrode assembly from swelling and to shorten a manufacturing process. In addition, even if a stack type electrode assembly, not a jelly roll type electrode assembly, is accommodated in a can type battery case 12, a plurality of unit cells may be laminated due to a pressure inside a battery case 12.

For this, as illustrated in FIG. 1, a method for manufacturing a secondary battery 1 according to an embodiment of the present invention includes: a process of accommodating an electrode assembly, in which electrodes and separators are alternately stacked, in a can type battery case 12; a process of primarily injecting an electrolyte through an injection hole 111; a process of applying a pressure to the battery case 12 while performing a formation process in a state in which the injection hole 111 is opened; a process of secondarily injecting the electrolyte through the injection hole 111, and a process of closing the injection hole 111. In addition, the process of applying the pressure while performing the formation process may include a process of primarily applying a first pressure while performing a primary formation process; and a process of secondarily applying a second pressure that is greater than the first pressure while performing a secondary formation process.

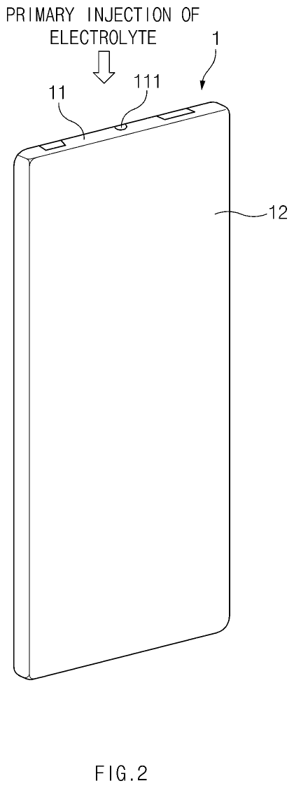

Hereinafter, each of the processs illustrated in the flowchart of FIG. 1 will be described with reference to FIGS. 2 to 5.

FIG. 2 is a schematic view illustrating a state in which the electrolyte is primarily injected into the secondary battery 1 according to an embodiment of the prevent invention.

A method for manufacturing the secondary battery 1 according to an embodiment of the present invention is largely classified into three processes such as an electrode plate process, an assembly process, and a formation process. The electrode plate process is a process of manufacturing a positive electrode and a negative electrode. Here, an active material may be applied to a base material to manufacture the positive electrode and the negative electrode.

The assembly process is a process of assembling the secondary battery 1. First, the positive and negative electrodes, which are manufactured as described above, and the separators may be alternately stacked to manufacture the electrode assembly. The electrode assembly is classified into a jelly roll type electrode assembly formed by stacking a long electrode sheet and separator sheet and then winding the sheets and a stack type electrode assembly in which at least portions of the plurality of electrodes and separators are laminated to be bonded to each other according to shapes of the electrode assembly.

In general, the jelly roll type electrode assembly is used in a can type secondary battery, and a stack type electrode assembly is used in a pouch type secondary battery. As described above, in the can type secondary battery, an injection hole is not completely closed while performing the formation process, and thus, a gas may partially remain inside the battery case. However, in the jelly roll type electrode assembly, since the laminating is not performed, there is no bonding between the electrode and the separator, and also, even if a gas is generated after the formation process, the gas may be smoothly discharged to the outside, and thus, since an amount of gag trapped in the battery case is small, a swelling phenomenon does not occur often.

However, in the jelly roll type electrode assembly, there is a problem in that the electrode and the separator are not bonded to each other, and thus, mobility of ions is lowered, and an energy density is also lowered. In addition, since a shape changes such as winding of the electrode, such as being wound, there is high possibility of occurrence of damage and cracks of the electrode.

On the other hand, in the stacked electrode assembly, since at least a portion is bonded by laminating the electrodes and the separators, an amount of gas trapped between the electrodes and the separators may be large when the formation process is performed. However, in the pouch type secondary battery, the formation process is performed after the battery case is completely sealed. In addition, the gas may be smoothly discharged to the outside through a separate degassing process to be later. Thus, the stack type electrode assembly having high energy density and low possibility of occurrence of damage may be used.

However, according to an embodiment of the present invention, in spite of the can type secondary battery 1, the stack type electrode assembly in which at least a portion of the electrodes and the separators is laminated is used. Therefore, the energy density is higher, and the possibility of occurrence of damage is low when compared to the can type secondary battery according to the related art. However, the gas generated in the formation process has to be more smoothly discharged.

According to the method for manufacturing the secondary battery 1 according to an embodiment of the present invention, first, the stack type electrode assembly is accommodated therein through an opening of the can type battery case 12, and the opening of the battery case 12 is covered (S101). When covering the opening of the battery case 12, a top cap assembly 11 or the like may be used. In addition, the opening of the battery case 12 may be covered by welding an outer wall of the battery case 12 to the top cap assembly 11.

As illustrated in FIG. 2, in the can type secondary battery 1 according to an embodiment of the present invention, the battery case 12 is made of a material having rigidity, such as a metal or plastic and thus is constantly maintained in outer appearance thereof. Although a prismatic type battery having a polyhedron or polygonal column shape is illustrated in FIG. 2, the embodiment of the present invention is not limited thereto. For example, the battery case 12 may be a cylinder type battery having a cylindrical shape. That is, if the battery case 12 is provided in the can type having a predetermined shape, various kinds of secondary batteries 1 may be provided without limitation.

As illustrated in FIG. 2, the electrolyte is primarily injected through the injection hole 111 formed in the battery case 12 (S102). Here, when primarily injecting the electrolyte, only a small amount of electrolyte has to be injected. If a large amount of electrolyte is injected, when a gas is discharged through the injection hole 111 later, the electrolyte injected into the battery case 12 may be discharged together with the gas to the outside by overflow. In addition, when the electrolyte is primarily injected, a pressure may be lowered so that the surroundings are close to a vacuum state. Therefore, impregnability of the electrolyte may be further improved.

After the secondary battery 1 is completely assembled as described above, a formation process is performed. The formation process is a process of forming an SEI layer on a surface of electrode plates of the electrode assembly to have electric charges. Thus, the secondary battery 1 may be finally charged through the formation process to supply power. As described above, in the can type secondary battery 1, the formation process may be performed without closing the injection hole 111. Here, in order to prevent moisture from being permeated, the formation process may be performed in a dry room.

After primarily injecting the electrolyte, and before performing the formation process, an aging process may be performed. The aging process is a process of storing the assembled secondary battery 1 for a predetermined time at specific temperature and humidity. Here, the electrolyte is sufficiently dispersed in the secondary battery 1 to optimize movement of ions. According to an embodiment of the present invention, the temperature for performing such the aging process may be between 20° C. to 30° C., in particular, preferably 25° C.

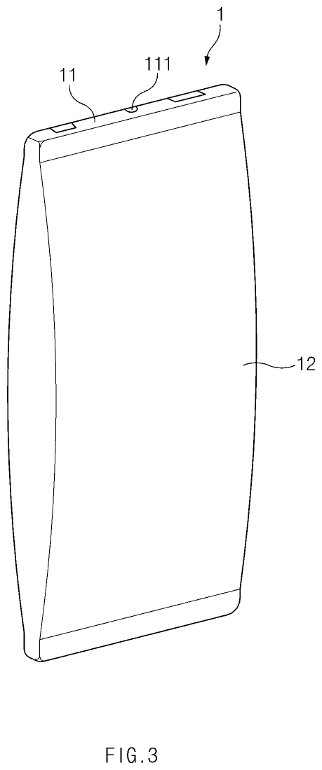

FIG. 3 is a schematic view illustrating a state in which the can type secondary battery swells.

When the formation process is performed, a gas may be generated inside the battery case 12. In order to easily discharge the gas to the outside, when performing the formation process, the injection hole 111 is not closed, but is maintained in an open state.

However, as described above, in order to complete the manufacture of the secondary battery 1 within the predetermined process time, only a portion of the gas may be discharged, and then, the injection hole 111 may be closed so that the gas partially remain inside the battery case 12. In particular, as described above, when the stack type electrode assembly is used in the can type secondary battery 1, an amount of gas trapped between the electrodes and the separators in the gas generated by performing the formation process may be large. As a swelling phenomenon in which the electrode assembly swells by the gas occurs, as illustrated in FIG. 3, a problem in that the secondary battery 1 increases in thickness.

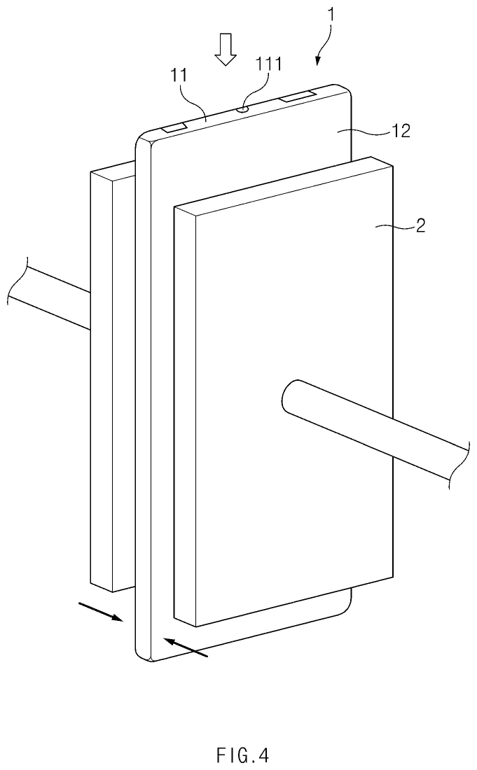

FIG. 4 is a schematic view illustrating a state in which the secondary battery 1 is pressed by a jig according to an embodiment of the present invention.

According to an embodiment of the present invention, as illustrated in FIG. 4, while the formation process is performed in the state in which the injection hole 111 is opened, a pressure is applied to the secondary battery 1 by using a jig 2.

Specifically, when a pressure is applied while performing the formation process, a first pressure may be primarily applied while performing a first formation process (S103), and then a second pressure that is greater than the first pressure may be secondarily applied while performing a second formation process (S104).

First, in order to perform the formation process on the secondary battery 1, an electrode terminal of the secondary battery 1 is connected to an external power source, and simultaneously, the secondary battery 1 is installed between the jigs 2. Then, while performing the first formation process, a primary pressure is applied as the first pressure. Here, when the primary formation process is performed, a large amount of gas is generated and then discharged to the outside through the opened injection hole 111. Thus, the first pressure for applying the primary pressure may be relatively weak that is enough to prevent the outer appearance of the secondary battery 1 from being deformed only by a large amount of gas. That is, the first pressure may be 0.5 kgf/cm² to 1 kgf/cm², in particular, preferably 0.5 kgf/cm² to 0.7 kgf/cm². If the first pressure is less than 0.5 kgf/cm², even if the injection hole 111 is opened, the outer appearance of the secondary battery 1 may be deformed by the large amount of gas. Conversely, if the first pressure is greater than 1 kgf/cm², there is no significantly different effect compared to the case of the pressure of 1 kgf/cm².

Then, the secondary pressure is applied while performing a secondary formation process. When a large amount of gas is generated, a portion of the gas may remain inside the battery case 12 or may be trapped in the electrode assembly. Thus, the second pressure for applying the secondary pressure may be relatively strong that is enough to allow the gas to remain inside the battery case 12 or to maximally discharge the trapped gas. That is, the second pressure may be 4.5 kgf/cm² to 10 kgf/cm², in particular, preferably 5.0 kgf/cm² to 7.0 kgf/cm². If the second pressure is less than 4.5 kgf/cm², the remaining or trapped gas may not be smoothly discharged to the outside. Conversely, if the second pressure is greater than 10 kgf/cm², the can type battery case 12 may be recessed inward and deformed, and also, the electrolyte inside the battery case 12 may be discharged to the outside.

According to another embodiment of the present invention, when a pressure is applied while performing the formation process as described above, the secondary battery 1 may be heated at a high temperature. The electrode assembly according to embodiments of the present invention is the stack type electrode assembly, and the stack type electrode assembly is formed by laminating at least a portion of the plurality of electrodes and separators. However, in the stack type electrode assembly, a non-laminated portion may exist, and as the electrode assembly increases in thickness, the non-laminated portion may increase.

In particular, the stack type electrode assembly includes a lamination & stack type electrode assembly, in which unit cells are stacked after the unit cells are manufactured, and a stack & folding type electrode assembly, in which a plurality of unit cells are attached to be spaced apart from each other on one surface of a separator sheet that is a long length in one direction, and then, the separator sheet is repeatedly folded from one end thereof in the same direction. In the case of the lamination & stack type or stack & folding type electrode assembly, the electrodes and the separators inside the unit cells may be easily bonded by a laminating process, but after the unit cells are stacked, the electrodes and the separators of the unit cells may not be easily bonded through the laminating process because the electrodes and the separators are already thick.

Therefore, when a pressure is applied while performing the formation process, the secondary battery 1 may be heated at a high temperature to discharge the remaining or trapped gas to the outside and also to additionally laminate non-laminated portion of the electrode assembly. When heating the secondary battery 1, it is preferable to heat the secondary battery 1, particularly, when applying the secondary pressure as the relatively strong second pressure, and the temperature is heated to 55° C. to 65° C. If the heating temperature is lower than 55° C., an effect of the laminating may be reduced. Conversely, if the heating temperature is higher than 65° C., the internal electrolyte may be evaporated, or the electrode assembly may be damaged.

It is preferable that the jig 2 for pressing the secondary battery 1 has a flat pressing surface to uniformly press the entire surface of both surfaces of the secondary battery 1. Also, as illustrated in FIG. 4, the jig 2 moves toward the secondary battery 1 to apply a pressure. In addition, after a predetermined time elapses, the jig 2 moves in a direction opposite to the secondary battery 1 to remove the pressure applied to the secondary battery 1. The jig 2 may also reciprocate in a vertical direction and a horizontal direction. Therefore, the pressure may be intensively applied to any position of the battery case 12 or an appropriate point intended by a user. In order for allowing the jig 2 to move easily in various directions, a piston or the like may be connected to an opposite surface of the pressing surface of the jig 2. In addition, the jig 2 may move by the piston in various manners without limitation, such as a mechanical system, a hydraulic system, and the like.

When performing the primary formation process, a charging rate may be approximately 23% or less, preferably 17% or less. In addition, when performing the secondary formation process, the charging rate may be higher than the above-described charging rate, for example, about 70% or less, preferably 65% or less.

As described above, according to an embodiment of the present invention, the formation process is performed in a state in which the injection hole 111 of the can type secondary battery 1 is opened, and the gas may be discharged to the outside through the injection hole 111. In addition, since the secondary battery 1 is pressed while performing the formation process, the gas may be discharged to the outside as much as possible. Thus, the gas remaining in the battery case 12 may be reduced to be minimized, thereby preventing the secondary battery 1 from increasing in thickness. In addition, even if a stack type electrode assembly, not a jelly roll type electrode assembly, is accommodated in a can type battery case 12, a plurality of unit cells may be laminated due to a pressure 12 inside a battery case.

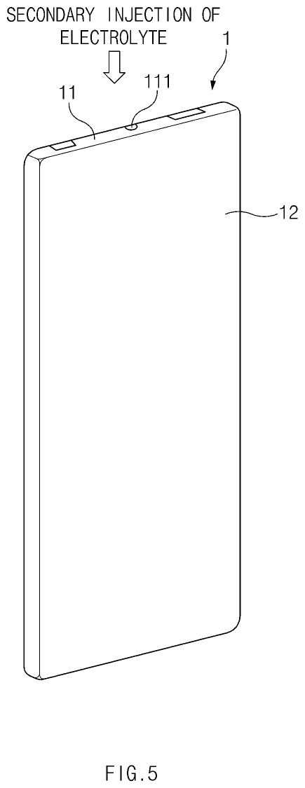

FIG. 5 is a schematic view illustrating a state in which the electrolyte is secondarily injected into the secondary battery 1 according to an embodiment of the prevent invention.

When the formation process is completed, as illustrated in FIG. 5, the electrolyte is injected secondarily. According to an embodiment of the present invention, even when the electrolyte is injected secondarily, the pressure may be lowered to be close to a vacuum state around the surroundings, or an injection device for secondarily injecting the electrolyte may suction the gas while injecting the electrolyte. Therefore, the gas still remaining inside the battery case 12 may be further discharged.

After the secondary injection of the electrolyte, the injection hole 111 is closed. As a result, the secondary battery 1 according to an embodiment of the present invention may be completely manufactured.

Those with ordinary skill in the technical field of the present invention pertains will be understood that the present invention can be carried out in other specific forms without changing the technical idea or essential features. Therefore, the above-disclosed embodiments are to be considered illustrative and not restrictive. Accordingly, the scope of the present invention is defined by the appended claims rather than the foregoing description and the exemplary embodiments described therein. Various modifications made within the meaning of an equivalent of the claims of the invention and within the claims are to be regarded to be in the scope of the present invention.

### DESCRIPTION OF THE SYMBOLS

| | |
|---|---|
| 1: Secondary battery | 2: Jig |
| 11: Top cap assembly | 12: Battery case |
| 111: Injection hole | |

1. A method for manufacturing a secondary battery, the method comprising:
accommodating an electrode assembly, in which electrodes and separators are alternately stacked, in a can type battery case;
primarily injecting an electrolyte through an injection hole;
applying a pressure to the battery case while performing a formation process in a state in which the injection hole is opened;
secondarily injecting the electrolyte through the injection hole after performing the formation process; and
closing the injection hole.

2. The method of claim 1, wherein the electrode assembly is a stack type electrode assembly in which at least portions of the electrodes and the separators are laminated.

3. The method of claim 1, wherein the applying of the pressure while performing the formation process comprises:
applying a primary pressure as a first pressure while performing a primary formation process; and
applying a secondary pressure as a second pressure that is greater than the first pressure while performing a secondary formation process.

4. The method of claim 3, wherein the first pressure is 0.5 kgf/cm² to 1 kgf/cm², and
wherein the second pressure is 4.5 kgf/cm² to 10 kgf/cm².

5. The method of claim 3, wherein, in the performing of the primary formation process, a charging rate is 23% or less.

6. The method of claim 5, wherein, in the performing of the secondary formation process, a charging rate is 70% or less.

7. The method of claim 1, wherein, in the applying of the pressure while performing the formation process, the battery case is heated.

8. The method of claim 7, wherein the battery case is heated at a temperature of 55° C. to 65° C.

9. The method of claim 1, further comprising performing aging after the primarily injecting of the electrolyte and before the applying of the pressure while performing the formation process.

10. The method of claim 9, wherein, in the performing of the aging, a temperature for the aging is 20° C. to 30° C.

11. The method of claim 1, wherein, in the secondarily injecting of the electrolyte, a gas remaining in the battery case is discharged to the outside.

12. A secondary battery manufactured using the method of claim 1,
wherein the electrode assembly is a stack type electrode assembly,
wherein at least portions of the electrodes and the separators are laminated with each other, and
wherein the can type battery case has a constant outer appearance.
